(19) United States
(12) Patent Application Publication
(10) Pub. No.: US 2019/0244316 A1
(43) Pub. Date: Aug. 8, 2019

(54) CONTROLLING METHOD AND SYSTEM FOR MATERIAL TRANSFER

(71) Applicants: HKC Corporation Limited, Shenzhen, Guangdong (CN); Chongqing HKC Optoelectronics Technology Co., Ltd., Chongqing (CN)

(72) Inventor: Po-Sung Pan, Shenzhen, Guangdong (CN)

(21) Appl. No.: 16/318,131

(22) PCT Filed: Oct. 23, 2017
(86) PCT No.: PCT/CN2017/107212

§ 371 Date: Jan. 15, 2019

(30) Foreign Application Priority Data
Jan. 18, 2017 (CN) 201710037113.2

(51) Int. Cl. G06Q 50/28; B65G 1/04

(52) U.S. Cl. CPC G06Q 50/28; B65G 1/04

(57) ABSTRACT

Disclosed a controlling method and a controlling system (100) for material transfer. The method includes the following operations: controlling a transporter to transport the material according to a preset path (10); reserving a storage location before the transporter stores the material, and obtaining a result storage location that stores the material according to a reservation result fed back by the storage location (20); and controlling the transporter to store the material in the result storage location (30).

### TECHNICAL FIELD

The present disclosure relates to the field of transfer technology, and more particularly relates to a controlling method and a controlling system for material transfer.

### BACKGROUND

Modern warehouse management is a kind of dynamic management that pays attention to the timeliness of storage. It pays attention to the change of the position of goods when picking and loading, so as to cooperate with other warehouse operations, and managers can know the amount, location, and destination of goods at any time during the operation. Because of the high efficiency of modern warehouse management, it has been widely used in the market.

In an exemplary technology, the target storage location is reserved in advance for materials, but the materials often cannot reach the target storage location for storage in a certain period of time, and the reserved target storage location can no longer accept storage of other materials, which greatly wastes the storage resources of the warehouse system, and reduce the storage efficiency of the entire warehouse system.

### SUMMARY

The present application provides a controlling method and system for material transfer, which aims to improve the flexibility and storage efficiency of the storage space of each storage location.

The controlling method for material transfer provided by the present application includes the following steps:

controlling a transporter to transport the material according to a preset path;

reserving a storage location before the transporter stores the material, and obtaining a result storage location that stores the material according to a reservation result fed back by the storage location; and

controlling the transporter to store the material in the result storage location.

In one embodiment, prior to the operation of reserving a storage location before the transporter stores the material, the method further comprising:

reserving a target storage location when the transporter arrives a last one storage location located in front of the target storage location.

In one embodiment, prior to the operation of reserving a storage location before the transporter stores the material, the method further includes:

reserving a target storage location when the transporter arrives a penultimate storage location located in front of the target storage location;

determining whether the target storage location is full; and

if yes, reserving the last one storage location located in front of the target storage location.

In one embodiment, the operation of controlling the transporter to store the material in the result storage location includes:

controlling the transporter to store the material in the result storage location when the last one storage location located in front of the target storage location is not full, and the result storage location is the last one storage location located in front of the target storage location.

In one embodiment, the operation of controlling a transporter to transport the material according to a preset path includes:

obtaining a demand intensity of multiple materials;

controlling the transporter preferentially to transport the material with high demand intensity according to the demand intensity.

The present application provides a controlling system for material transfer, comprising a transporting module, a reserving module, and a storing module;

the transporting module is configured to control a transporter to transport the material according to a preset path;

the reserving module is configured to reserve a storage location before the transporter stores the material, and obtain a result storage location that stores the material according to a reservation result fed back by the storage location; and

the storing module is configured to control the transporter to store the material in the result storage location.

In one embodiment, the reserving module includes:

a first reserving unit, being configured to reserve a target storage location when the transporter arrives at a last one storage location located in front of the target storage location.

In one embodiment, the reserving module includes a second reserving unit, a determining unit, and a third reserving unit; and

the second reserving unit is configured to reserve the target storage location when the transporter arrives at a penultimate storage location located in front of the target storage location;

the determining unit is configured to determine whether the target storage location is full; and

the third reserving unit is configured to reserve the last one storage location located in front of the target storage location when the target storage location is full.

In one embodiment, the storing module is further configured to control the transporter to store the material in the result storage location when the last one storage location located in front of the target storage location is not full, and the result storage location is the last one storage location located in front of the target storage location.

In one embodiment, the transporter includes an obtaining unit and a transporting unit.

the obtaining unit is configured to obtain a demand intensity of multiple materials; and

the transporting unit is configured to control the transporter preferentially to transport the material with high demand intensity according to the demand intensity.

The application by controlling a transporter to transport the material according to a preset path; reserving a storage location before the transporter stores the material, and obtaining a result storage location that stores the material according to a reservation result fed back by the storage location; and controlling the transporter to store the material in the result storage location. So that the reservation time of each storage location in the system is greatly shortened, and the other materials can be stored and unloaded in a shortened time. Increased the flexibility of the storage system and improved the storage efficiency of the storage system.

### BRIEF DESCRIPTION OF THE ACCOMPANYING DRAWINGS

To illustrate the technical scheme of the embodiment of the present application or other exemplary technology more clearly, a brief description of the drawings to be used in the description of the embodiment or exemplary technology will be given below. Obviously, the drawings described below are only some of the embodiments of the application. And for those of ordinary skill in the art, other drawings may be obtained based on these drawings without creative effort.

FIG. 1 is an illustrative flowchart of an embodiment of a controlling method for material transfer in accordance with this disclosure;

FIG. 2 is an illustrative flowchart of another embodiment of a controlling method for material transfer in accordance with this disclosure;

FIG. 3 is a schematic structural diagram in a further embodiment of a controlling method for material transfer in accordance with this disclosure;

FIG. 4 is an illustrative flowchart in a further embodiment of a controlling method for material transfer in accordance with this disclosure;

FIG. 5 is a schematic structural diagram as the target storage location is not full in a further embodiment of a controlling method for material transfer in accordance with this disclosure;

FIG. 6 is a schematic structural diagram as the target storage location is full and the previous storage location is not full in a further embodiment of a controlling method for material transfer in accordance with this disclosure;

FIG. 7 is an illustrative flowchart of another embodiment of a controlling method for material transfer in accordance with this disclosure;

FIG. 8 is a schematic diagram of functional blocks of an embodiment of a controlling system for material transfer in accordance with this disclosure;

FIG. 9 is a schematic diagram of refinement functional blocks of a reserving module in another embodiment of a controlling system for material transfer in accordance with this disclosure;

FIG. 10 is a schematic diagram of refinement functional blocks of a reserving module in a further embodiment of a controlling system for material transfer in accordance with this disclosure;

FIG. 11 is a schematic diagram of refinement functional blocks of a transporting module in another embodiment of a controlling system for material transfer in accordance with this disclosure.

Various implementations, functional features, and advantages of this disclosure will now be described in further detail in connection with some illustrative embodiments and the accompanying drawings.

### DETAILED DESCRIPTION OF ILLUSTRATIVE EMBODIMENTS

The technical schemes in the embodiments of the present application are clearly and completely described in the following embodiments with drawings of the present application. It is obvious that the described embodiments are only a part, not all, of the embodiments of the present application. All other embodiments obtained by an ordinary skilled person in the art based on the embodiments of the present application without departing from the inventive scope are fall into the scope of the present application.

It should be noted that all directional indicators (such as “up” “down” “left” “right” “front” or “rear”) as merely used to illustrate the relative positions and movements or the like of various components or parts under a specific posture (as depicted in the drawings), and if the specific posture change, these directional indicators will change accordingly.

In addition, the descriptions of “first”, “second” and the like in this application are used for descriptive purposes only and are not to be construed as indicating or implying a relative importance or implicitly indicating the number of technical features. Thus, features defined by “first” and “second” may include at least one of the features either explicitly or implicitly. In addition, the technical solutions between the various embodiments may be combined with each other, but must be based on the realization of those skilled in the art, and when the combination of the technical solutions is contradictory or impossible to implement, it should be considered that the combination of the technical solutions does not exist. Nor is it within the scope of protection required by this application.

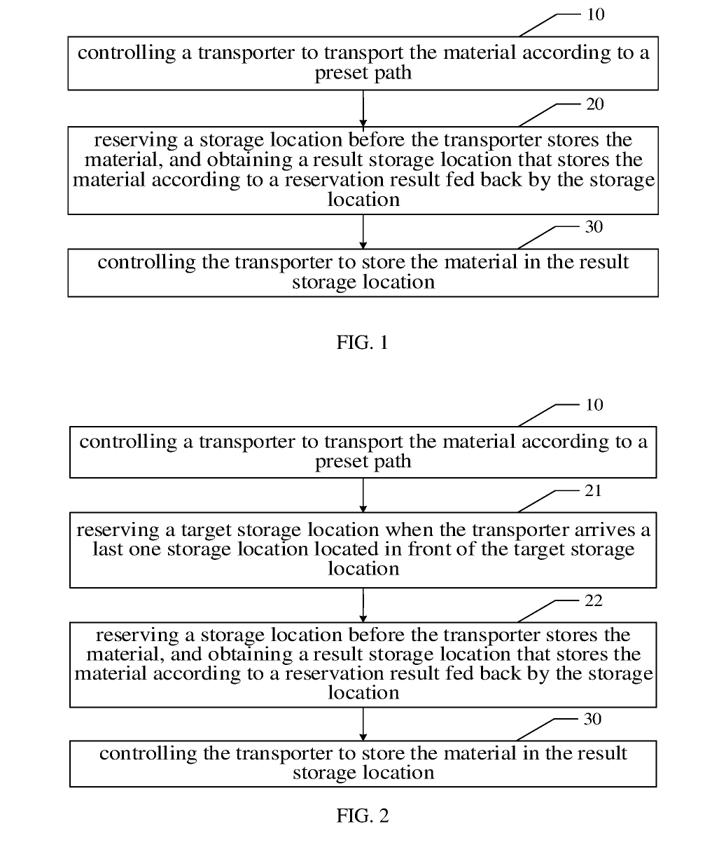

The present application provides a controlling method for material transfer, such as a material transfer that can be applied to a display panel. Referring to FIG. 1, in an embodiment, the material transfer control method includes S10 to S30.

In S10, controlling a transporter to transport the material according to a preset path.

In the storage system, there are a plurality of transmission paths between the material inlet and the storage location, the storage location and the storage location, and the storage location and the material outlet. The plurality of transmission paths may be connected to each other or may be independent of each other. The material may pass through other storage locations when transported in the transmission path.

The transmission path may be a transmission track or a road. In this embodiment, it is not limited, and the transporter moves on the transmission path. In this embodiment, the transporter completes the transportation of the material by transporting the cassette loaded with the material.

In S20, reserving a storage location before the transporter stores the material, and obtaining a result storage location that stores the material according to a reservation result fed back by the storage location.

In S30, controlling the transporter to store the material in the result storage location.

The storage location includes a quantity of storage space and a handling device for loading and unloading material within the storage location. The handling device storing material into and unloading the material from the storage space. In addition, the storage location further includes a fan filter unit, the fan draws air from the top and filters through the primary and high-efficiency filters. The filtered clean air is blown at a uniform speed across the cover, thereby maintaining the storage space with a high-level clean environment.

After the transporter travels for a period of time on the transport path, the controller makes a reservation to the storage location before depositing the material, and obtains a storage condition of the storage location. In the case that the storage location has space, the material is stored in a storage space of the storage location. If there is no space, the material is stored in a storage space of other storage locations that having space.

In this embodiment, the material is transported according to a preset path; the storage location is reserved before the material reaches, and the material is stored according to the storage condition of the storage location. So that the storage location reservation time is greatly shortened. And during the shortened period, the storage space of the storage location can be used for storing and unloading other materials, which greatly improves the flexibility of the storage system and improves the storage efficiency of the storage system.

Further, in this embodiment, the form of transferring the material is high-altitude transmission, and the material is carried at a high altitude. So that the material does not affect the normal space operation of the storage location during the transmission process, and also avoids unnecessary product contamination.

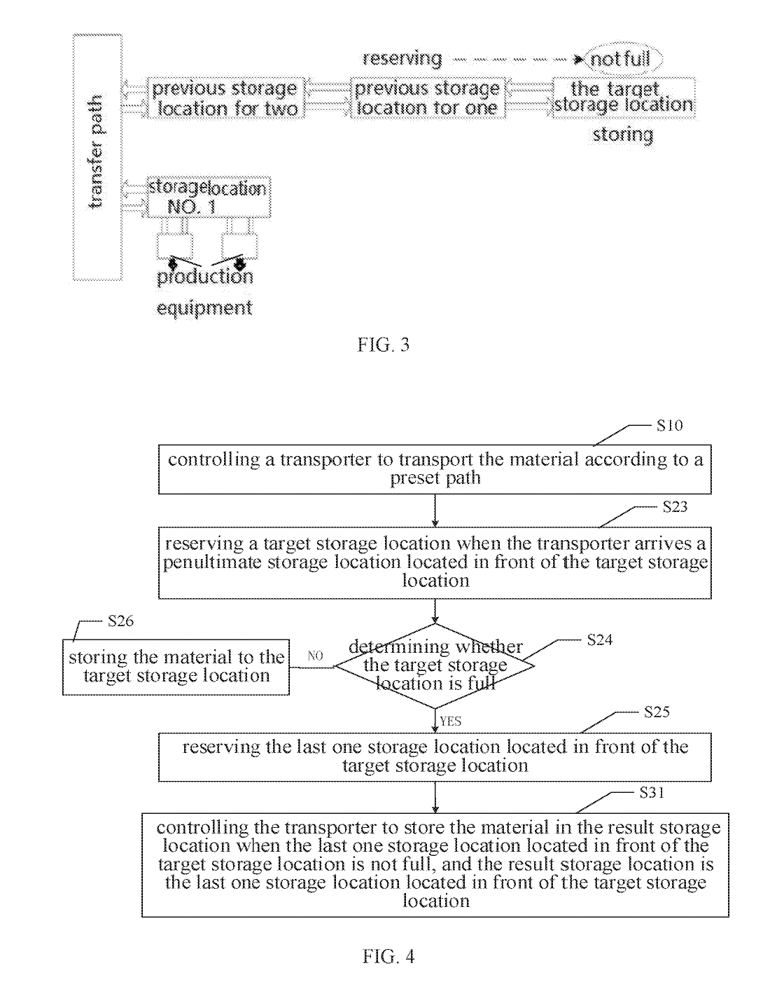

Further, referring to FIG. 2 and FIG. 3, based on an embodiment of the controlling method for material transfer of the present application, in another embodiment, the foregoing step S20 includes S21 to S22.

In S21, reserving a target storage location when the transporter arrives a last one storage location located in front of the target storage location.

In S22, reserving a storage location before the transporter stores the material, and obtaining a result storage location that stores the material according to a reservation result fed back by the storage location.

In this embodiment, reserving the target storage location at the previous storage location of it can shorten the reservation time to the greatest extent, so that the storage space of the target storage location is reserved for the shortest time, and material can be timely deposited and sent out, which maximize the flexibility and storage efficiency of the storage space of the target storage location.

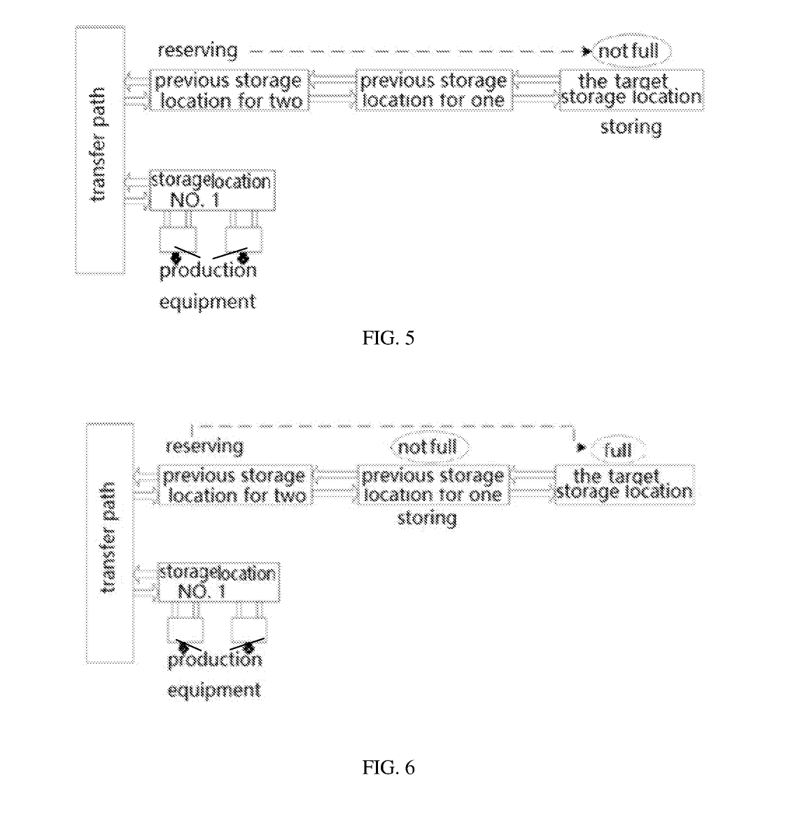

Further, referring to FIG. 4 to FIG. 6, in another embodiment of the controlling method for material transfer of the present application, the step S20 further includes S23 to S26.

In S23, reserving a target storage location when the transporter arrives a penultimate storage location located in front of the target storage location.

In S24, determining whether the target storage location is full.

In S25, if yes, reserving the last one storage location located in front of the target storage location.

In S26, if not, storing the material to the target storage location.

Further, the above step S30 further includes S31.

In S31, controlling the transporter to store the material in the result storage location when the last one storage location located in front of the target storage location is not full, and the result storage location is the last one storage location located in front of the target storage location.

In this embodiment, after the material is transmitted through the preset path for a period of time, the target storage location is reserved when the material reaches a storage location that previous to the target storage location for two target storage locations. And when the space of the target storage location is not full, the material is stored in the target storage location; when the space of the target storage location is full, reserving the storage location that previous to the target storage location for one storage location. And the material is stored in the previous storage location when the storage space of the previous storage location is not full. It makes the material storage method more flexible, and can respond in time to the situation where the storage space of the target storage location is insufficient.

Further, when the space of the target storage location is full, the storage location that previous to the target storage location for one storage location is reserved. And the material transfer controlling system changes the address of the target storage location automatically to the address of the storage location that previous to the target storage location for one storage location before the storage space of the target storage location is unloaded to a preset value. For example, the target storage location is the 27th storage location, and the 26th storage location is reserved when the storage space of the 27th storage location is insufficient, and the material is stored in the area for storing of the 26th storage location if the storage space of the 26th storage location is sufficient. And a changing operation is triggered, that is, changing the target storage location from the 27th to the 26th. At this time, a predetermined storage space value of 75% is set for the 27th storage location. When the occupied storage space of the 27th storage location is greater than 75%, the target storage location is still the 26th; when the occupied storage space of the 27th is less than or equal to the 75%, the target storage location is changed back to the 27th storage location. The predetermined storage space value can be any arbitrarily set value, and is set according to the actual demand of the storage system.

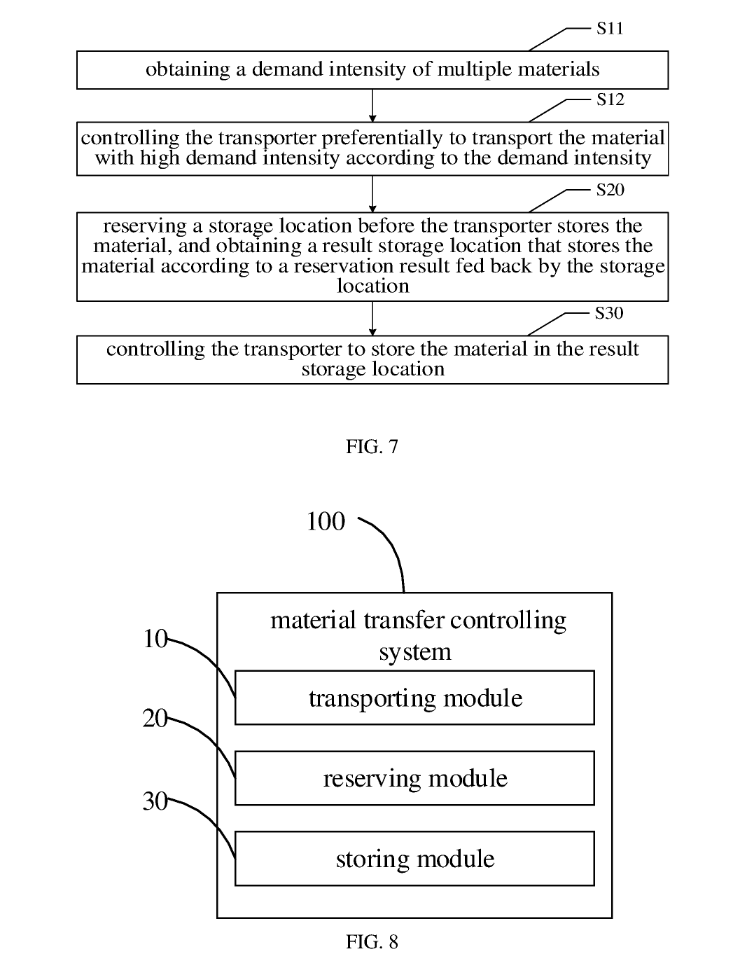

Further, referring to FIG. 7, based on an embodiment of the controlling method for material transfer of the present application, in a further embodiment, the foregoing step S10 includes S11 to S12.

In S11, obtaining a demand intensity of multiple materials.

The demand tension of a plurality of materials in production is obtained in real time. That is, when the material is likely to be out of stock during the production process, the demand tension for the material is high. In the case of the same amount of storage, which material is consumed faster, the demand tension of the material is high.

In S12, controlling the transporter preferentially to transport the material with high demand intensity according to the demand intensity.

In this embodiment, the demand tension of the plurality of materials in the production is obtained in real time, and the transporter is controlled to preferentially transmit the materials with high demand tension. So that the materials that are relatively easy to be out of the production line are timely replenished, and avoiding irreparable damage caused by out of stock on the production line.

The present application provides a material transfer controlling system, such as a material transfer that can be applied to a display panel. Referring to FIG. 8, in an embodiment, the material transfer control system includes a transporting module 10, a reserving module 20, and a storing module 30.

The transporting module 10 is configured to control a transporter to transport the material according to a preset path.

In the storage system, there are a plurality of transmission paths between the material inlet and the storage location, the storage location and the storage location, and the storage location and the material outlet. The plurality of transmission paths may be connected to each other or may be independent of each other. The material may pass through other storage locations when transported in the transmission path.

The transmission path may be a transmission track or a road. In this embodiment, it is not limited, and the transporter moves on the transmission path. In this embodiment, the transporter completes the transportation of the material by transporting the cassette loaded with the material.

The reserving module 20 is configured to reserve a storage location before the transporter stores the material, and obtain a result storage location that stores the material according to a reservation result fed back by the storage location.

The storing module 30 is configured to control the transporter to store the material in the result storage location.

The storage location includes a quantity of storage space and a handling device for loading and unloading material within the storage location. The handling device storing material into and unloading the material from the storage space. In addition, the storage location further includes a fan filter unit, the fan draws air from the top and filters through the primary and high-efficiency filters. The filtered clean air is blown at a uniform speed across the cover, thereby maintaining the storage space with a high-level clean environment.

After the transporter travels for a period of time on the transport path, the controller makes a reservation to the storage location before depositing the material, and obtains a storage condition of the storage location. In the case that the storage location has space, the material is stored in a storage space of the storage location. If there is no space, the material is stored in a storage space of other storage locations that having space.

In this embodiment, the material is transported according to a preset path; the storage location is reserved before the material reaches, and the material is stored according to the storage condition of the storage location. So that the storage location reservation time is greatly shortened. And during the shortened period, the storage space of the storage location can be used for storing and unloading other materials, which greatly improves the flexibility of the storage system and improves the storage efficiency of the storage system.

Further, in this embodiment, the form of transferring the material is high-altitude transmission, and the material is carried at a high altitude. So that the material does not affect the normal space operation of the storage location during the transmission process, and also avoids unnecessary product contamination. Specifically, the transporter is a high altitude transporter.

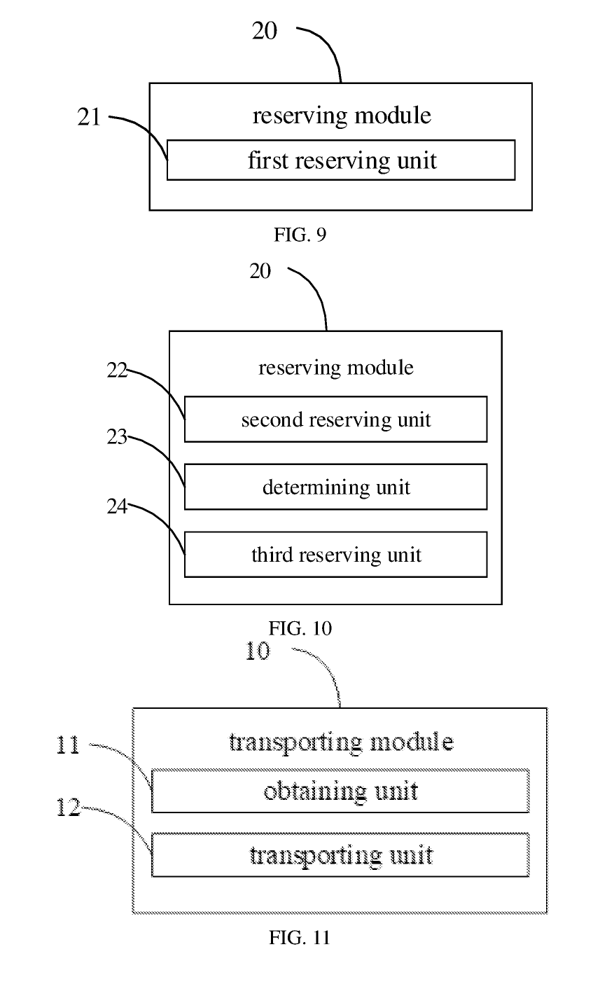

Further, referring to FIG. 9, based on an embodiment of the material transfer controlling system of the present application, in a further embodiment, the reserving module 20 includes:

a first reserving unit 21, being configured to reserve a target storage location when the transporter arrives at a last one storage location located in front of the target storage location.

In this embodiment, reserving the target storage location at the previous storage location of it can shorten the reservation time to the greatest extent, so that the storage space of the target storage location is reserved for the shortest time, and material can be timely deposited and sent out, which maximize the flexibility and storage efficiency of the storage space of the target storage location.

Further, referring to FIG. 10, based on an embodiment of the material transfer controlling system of the present application, in a further embodiment, the reserving module 20 also includes a second reserving unit 22, a determining unit 23, and a third reserving unit 24.

The second reserving unit 22 is configured to reserve the target storage location when the transporter arrives at a penultimate storage location located in front of the target storage location.

The determining unit 23 is configured to determine whether the target storage location is full.

The third reserving unit 24 is configured to reserve the last one storage location located in front of the target storage location when the target storage location is full.

Further, the storing module 30 is also configured to control the transporter to store the material in the result storage location when the storage location previous to the target storage location is not full, and the result storage location is the storage location that previous to the target storage location for one storage location.

In this embodiment, after the material is transmitted through the preset path for a period of time, the target storage location is reserved when the material reaches a storage location that previous to the target storage location for two target storage locations. And when the space of the target storage location is full, reserving the storage location that previous to the target storage location for one storage location. And the material is stored in the previous storage location when the storage space of the previous storage location is not full. It makes the material storage method more flexible, and can respond in time to the situation where the storage space of the target storage location is insufficient.

Further, when the space of the target storage location is full, the storage location that previous to the target storage location for one storage location is reserved. And the material transfer controlling system changes the address of the target storage location automatically to the address of the storage location that previous to the target storage location for one storage location before the storage space of the target storage location is unloaded to a preset value. For example, the target storage location is the 27th storage location, and the 26th storage location is reserved when the storage space of the 27th storage location is insufficient, and the material is stored in the area for storing of the 26th storage location if the storage space of the 26th storage location is sufficient. And a changing operation is triggered, that is, changing the target storage location from the 27th to the 26th. At this time, a predetermined storage space value of 75% is set for the 27th storage location. When the occupied storage space of the 27th storage location is greater than 75%, the target storage location is still the 26th; when the occupied storage space of the 27th is less than or equal to the 75%, the target storage location is changed back to the 27th storage location. The predetermined storage space value can be any arbitrarily set value, and is set according to the actual demand of the storage system.

Further, referring to FIG. 11, based on an embodiment of the controlling method for material transfer of the present application, in a further embodiment, the transporter 10 includes an obtaining unit 11 and a transporting unit 12.

The obtaining unit 11 is configured to obtain a demand intensity of multiple materials.

The demand tension of a plurality of materials in production is obtained in real time. That is, when the material is likely to be out of stock during the production process, the demand tension for the material is high. In the case of the same amount of storage, which material is consumed faster, the demand tension of the material is high.

The transporting unit 12 is configured to control the transporter preferentially to transport the material with high demand intensity according to the demand intensity.

In this embodiment, the demand tension of the plurality of materials in the production is obtained in real time, and the transporter is controlled to preferentially transmit the materials with high demand tension. So that the materials that are relatively easy to be out of the production line are timely replenished, and avoiding irreparable damage caused by out of stock on the production line.

The foregoing description merely portrays some optional embodiments according to the disclosure and therefore is not intended to limit the patentable scope of the disclosure. Any equivalent structural or flow transformations that are made taking advantage of the specification and accompanying drawings of the disclosure and any direct or indirect applications thereof in other related technical fields shall all fall in the scope of protection of the disclosure.

What is claimed is:

1. A controlling method for material transfer, wherein the controlling method comprises:
controlling a transporter to transport the material according to a preset path;
reserving a storage location before the transporter stores the material, and obtaining a result storage location that stores the material according to a reservation result fed back by the storage location; and
controlling the transporter to store the material in the result storage location.

2. The method of claim 1, further comprising, prior to the operation of reserving a storage location before the transporter stores the material:
reserving a target storage location when the transporter arrives a last one storage location located in front of the target storage location.

3. The method of claim 2, wherein the operation of controlling the transporter to store the material in the result storage location comprises:
controlling the transporter to store the material in the result storage location when the last one storage location located in front of the target storage location is not full, and the result storage location is the last one storage location located in front of the target storage location.

4. The method of claim 1, further comprising, prior to the operation of reserving a storage location before the transporter stores the material:
reserving a target storage location when the transporter arrives a penultimate storage location located in front of the target storage location;
determining whether the target storage location is full; and
if yes, reserving the last one storage location located in front of the target storage location.

5. The method of claim 4, wherein the operation of controlling the transporter to store the material in the result storage location comprises:
controlling the transporter to store the material in the result storage location when the last one storage location located in front of the target storage location is not full, and the result storage location is the last one storage location located in front of the target storage location.

6. The method of claim 5, wherein the operation of controlling the transporter to store the material in the result storage location further comprises:
changing the address of the target storage location automatically to the address of the last one storage location located in front of the target storage location before the target storage location is unloaded to a preset storage space value.

7. The method of claim 1, wherein the operation of controlling a transporter to transfer the material according to a preset path comprises:
obtaining a demand intensity of multiple materials;
controlling the transporter preferentially to transport the material with high demand intensity according to the demand intensity.

8. A controlling system for material transfer, comprising a transporting module, a reserving module, and a storing module, wherein
the transporting module is configured to control a transporter to transport the material according to a preset path;
the reserving module is configured to reserve a storage location before the transporter stores the material, and obtain a result storage location that stores the material according to a reservation result fed back by the storage location; and
the storing module is configured to control the transporter to store the material in the result storage location.

9. The controlling system of claim 8, wherein the reserving module comprises:
a first reserving unit, being configured to reserve a target storage location when the transporter arrives at a last one storage location located in front of the target storage location.

10. The controlling system of claim 9, wherein the storing module is further configured to control the transporter to store the material in the result storage location when the last one storage location located in front of the target storage location is not full, and the result storage location is the last one storage location located in front of the target storage location.

11. The controlling system of claim 8, wherein the reserving module comprises a second reserving unit, a determining unit, and a third reserving unit, wherein:
the second reserving unit is configured to reserve the target storage location when the transporter arrives at a penultimate storage location located in front of the target storage location;
the determining unit is configured to determine whether the target storage location is full; and
the third reserving unit is configured to reserve the last one storage location located in front of the target storage location when the target storage location is full.

12. The controlling system of claim 11, wherein the storing module is further configured to control the transporter to store the material in the result storage location when the last one storage location located in front of the target storage location is not full, and the result storage location is the last one storage location located in front of the target storage location.

13. The controlling system of claim 12, wherein the storing module further comprises a changing unit,
and the changing unit is configured to change the address of the target storage location automatically to the address of the last one storage location that located in front of the target storage location before the target storage location is unloaded to a preset storage space value.

14. The controlling system of claim 8, wherein the transporter comprises an obtaining unit and a transporting unit, wherein:
the obtaining unit is configured to obtain a demand intensity of multiple materials; and
the transporting unit is configured to control the transporter preferentially to transport the material with high demand intensity according to the demand intensity.

15. A controlling method for material transfer, wherein the controlling method comprises:
controlling a transporter to sequentially transport materials according to the order of a demand intensity of the materials, on corresponding preset paths of the materials;
before the transporter stores the material, reserving a preset storage location when the transporter is at a preset distance from the preset storage location, and obtaining a result storage location that stores the material according to a reservation result fed back by the preset storage location; and
controlling the transporter to store the material in the result storage location.

16. The controlling method of claim 15, wherein the operation of before the transporter storing the material reserving a preset storage location when the transporter being at a preset distance from the preset storage location, comprises:
reserving the preset storage location when the transporter arrives a penultimate storage location that located in front of the preset storage location;
determining whether the preset storage location is full; and
if yes, reserving a last one storage location that located in front of the preset storage location.

17. The controlling method of claim 16, wherein the operation of controlling the transporter to store the material in the result storage location comprises:
controlling the transporter to store the material in the result storage location when the last one storage location located in front of the preset storage location is not full, and the result storage location is the last one storage location located in front of the preset storage location.

18. The controlling method of claim 17, wherein the operation of controlling the transporter to store the material in the result storage location further comprises:
changing the address of the preset storage location automatically to the address of the last one storage location located in front of the preset storage location before the preset storage location is unloaded to a preset storage space value.
